(19) United States
(12) Patent Application Publication
(10) Pub. No.: US 2016/0001210 A1
(43) Pub. Date: Jan. 7, 2016

(54) ARRANGEMENT AND METHOD FOR CLEANING A FILTER APPARATUS OF A PRODUCT GAS LINE OF A PLANT PRODUCING PRODUCT GAS

(71) Applicant: Valmet Technologies Oy, Espoo (FI)

(72) Inventors: Juhani Isaksson, Tampere (FI); Piia Keitaanniemi, Tampere (FI); Vesa Helanti, Lempaeaelae (FI)

(21) Appl. No.: 14/790,484

(22) Filed: Jul. 2, 2015

(30) Foreign Application Priority Data
Jul. 7, 2014 (FI) 20145653

(51) Int. Cl. B01D 46/00

(52) U.S. Cl. CPC B01D 46/006

(57) ABSTRACT

An arrangement and method for cleaning a filter apparatus (3) arranged to a product gas line (2) of a product gas producing plant (1). In the method a filter (5) of the filter apparatus (3) is separated from the product gas line (2) with closing means (4), oxygen-containing control gas (CG) is fed into the filter (5) separated from the product gas line (2), the control gas (CG) forming at least part of the regeneration gas (RG) cleaning the filter (5), and the regeneration gas (RG) that has passed through the filter (5) is removed from the filter (5).

### CROSS-REFERENCE TO RELATED APPLICATIONS

This application claims priority to and the benefit of Finnish Patent Application Serial No. 20145653, filed Jul. 7, 2014; the contents of which as are hereby incorporated by reference in their entirety.

### BACKGROUND

1. Related Field

Various embodiments of the present invention relate to an arrangement for cleaning a filter apparatus arranged to a product gas line of a plant producing product gas.

Various embodiments of the present invention also relate to a method for cleaning a filter apparatus arranged to a product gas line of a plant producing product gas

2. Description of Related Art

Product gas is filtered in plants producing product gas in order to remove particles contained in the gas. Impurities in product gas may block the filter elements. Dirt consisting of carbon and hydrocarbons, “tars”, may accumulate in the filters. It is known in the art to remove the dirt by driving the process in oxidizing conditions, if necessary, to clean the filters.

Driving the process in oxidizing conditions causes combustion in carbon and hydrocarbon layers, thus producing high temperatures and great local and temporal temperature variations. The temperature of the filters may locally exceed the capacity of the filter structures or the filters.

Oxygen content may be controlled by feeding inert gas into the gas flow, although most often the availability of inert gas restricts the feed volume. As a further consequence, the filters must be cleaned using a low total flow, and the cleaning is extremely slow. Moreover, a low flow is poorly distributed to the filters, thus leading to an non-uniform filtering result.

Difficult process manageability often leads to local overheating and thus to damages in the filters, which in turn reduce the usability of the filters.

### BRIEF SUMMARY

Having this background, the arrangement and method of various embodiments of the invention are characterized by what is disclosed in the independent claims. Other embodiments of the invention are characterised by what is disclosed in the other claims.

Inventive embodiments are also disclosed in the specification and drawings of this application. The inventive contents of the application may also be defined in ways other than those described in the following claims. The inventive contents may also consist of several separate inventions, particularly if the invention is examined in the light of expressed or implicit sub-tasks or in view of obtained benefits or benefit groups. In such a case, some of the definitions contained in the following claims may be unnecessary in view of the separate inventive ideas. Features of the different embodiments of the invention may be applied to other embodiments within the scope of the basic inventive idea.

The idea of the invention is to regenerate a filter by oxidizing dirt accumulated on the filter by controlling the oxygen content of the regeneration gas. In the following, features of some embodiments of the invention are listed in a random order.

According to an embodiment, the arrangement comprises measuring means for measuring oxygen content in the regeneration gas that is to be fed into the filter and/or that has passed through the filter, measuring means for measuring the temperature of the regeneration gas that is to be fed into the filter and/or that has passed through the filter, and, in addition, adjusting means for adjusting a control gas flow on the basis of the above measurements. An advantage is that overheating of the filter may be avoided and that it is possible to detect when the filter has been cleaned and the regeneration may be stopped.

According to an embodiment, the closing means comprise a first closing arrangement in the product gas line, before the feed channel, and a second closing arrangement in the product gas line, after the discharge channel. An advantage is that the filter may be separated from the product gas line.

According to an embodiment, the regeneration means comprise a fan for forcing the regeneration gas through the filter and/or a heater for controlling the temperature of the regeneration gas. An advantage is that the regeneration of the filter may be speeded up and the regeneration process optimized.

According to an embodiment, the control gas to be used is oxygen or a gas mixture comprising oxygen, such as air or flue gas. An advantage is that dirt left in the filter may be oxidized in a controlled manner.

According to an embodiment, the arrangement further comprises scavenging means for scavenging a filter separated from the product gas line by inert scavenging gas, such as carbon dioxide, nitrogen or water vapour. An advantage is that compounds harmful to regeneration or its regeneration process can be removed prior to the actual regeneration.

According to an embodiment, the channel system comprises a recirculation channel arranged between the discharge channel and the feed channel to recirculate into the feed channel regeneration gas that has passed through the filter. An advantage is that the temperature and composition of the regeneration gas may be controlled better and higher flow rates may be obtained without using a great volume of regeneration gas.

According to an embodiment, the filter apparatus comprises a plural number of parallel filters grouped into at least two cleaning groups and the cleaning is arranged to take place according to cleaning groups. An advantage is that production of the product gas may be continued during the cleaning process.

According to an embodiment, the regeneration gas flow rate is at least equal to a normal product gas flow through the filter in question. An advantage is that this allows the cleaning process to be speeded up and, at the same time, it is possible to target the cleaning process uniformly on different areas of the filter.

According to an embodiment, the regeneration gas flow rate is lower than a normal product gas flow rate through the filter in question. An advantage is that the equipment required by the arrangement may be dimensioned to fit even in tight spaces and according to the regeneration needed.

According to an embodiment, the regeneration gas flown through the filter is cooled. An advantage is that overheating of the filter and the arrangement may be avoided.

According to an embodiment, the regeneration gas to be conveyed through the filter is heated. An advantage is that the activation of the cleaning process may be speeded up.

According to an embodiment, the regeneration gas may be fed through the filter in the product gas flow direction or in an opposite direction. An advantage is that the arrangement is easily adjustable according to requirements of the application site.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic view of an arrangement and method applied to a plant producing hot product gas;

FIG. 2 is a schematic view of an arrangement and method;

FIGS. 3a, 3b are schematic views of some arrangements and methods; and

FIGS. 4a, 4b are schematic views of some embodiments of an arrangement and method.

In the figures, the invention is shown simplified for the sake of clarity. In the figures, like reference numerals identify like elements.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Still further, to facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

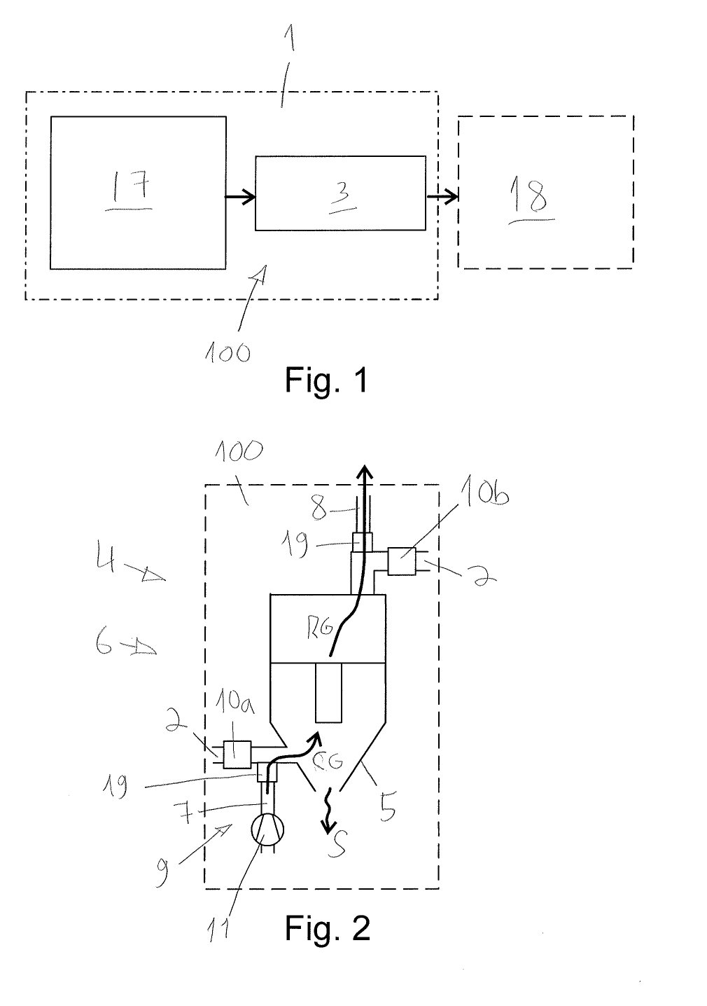

FIG. 1 is a schematic view of an arrangement and method applied to a plant producing hot product gas. In the figure, a plant 1 producing product gas is depicted by a line of dots and dashes. The plant in question comprises a product gas production unit 17, which may be a gasification plant or a pyrolysis plant, for example, known per se.

The product gas producing plant 1 further comprises a product gas line 2 along which the product gas produced by a producing unit 17 is conveyed for use at a product gas utilization unit 18. The utilization unit 18 may be arranged close to the product gas producing plant 1, or, it may be further away, in which case the product gas is delivered to the utilization unit 18 by a prior art method known per se. The product gas produced by the product gas producing plant 1 may be delivered for use in one or more utilization units 18.

The product gas producing plant 1 comprises a filter apparatus 3 arranged to the product gas line 2 to purify the product gas in order to remove particles contained therein. In association with the filter apparatus 3, there is an arrangement 100 arranged to clean or regenerate the filters of the filter apparatus 3.

FIG. 2 is a schematic sectional view of an arrangement and a method for cleaning filters. The arrangement 100 includes a channel system 6 connected to a filter 5 and comprising a feed channel 7 and a discharge channel 8. The feed channel 7 and the discharge channel 8 are preferably connected to the filter 5 through closing means 19, such as closing valves.

The arrangement 100 comprises closing means 4 with which the filter 5 of the filter apparatus 3 that is to be cleaned may be separated from the product gas line 2. In the present embodiment the closing means 4 comprise a first closing arrangement 10a, which is arranged to the product gas line 2 before the feed channel 7, and a second closing arrangement 10b, which is arranged to the product gas line 2 after the discharge channel 8. The closing arrangement 10a, 10b may comprise e.g. a valve, sliding trap or welded blind flange that may be installed as a block into the product gas line 2.

The arrangement 100 further comprises regeneration means 9 for feeding control gas CG containing oxygen through the feed channel 7 into the filter 5 separated from the product gas line 2. In this embodiment the control gas CG forms the gas that cleans the filter, i.e. the regeneration gas. The regeneration means 9 may comprise a fan 11 that generates a pressure difference for forcing the regeneration gas RG through the filter 5.

Said control gas may be a gas mixture comprising oxygen, for example, such as air or flue gas. By adjusting the oxygen content it is possible to control a temperature rise taking place during the cleaning in the filter 5. At least some of the material remaining in the filter 5 becomes oxidized by the influence of the regeneration gas RG. The target value for the temperature rise is case-specific and depends on the allowed temperatures of the filter 5. The target temperature may be 350° C., for example, although it is preferably equal to the highest operating temperature of the filter 5 at the most. Within this temperature range, the most typical oxidation processes take place rapidly. According to an idea, the oxygen content of the regeneration gas RG entering the filter 5 is 5% at the most.

According to an idea, the flow rate of the regeneration gas RG through the filter 5 is adjusted to be at least equal to a normal product gas flow rate through said filter 5. In some cases the flow rate of the regeneration gas RG is lower than that of normal product gas. To put it briefly, the volume of gas is dimensioned so as to achieve a desired regeneration time, and hence the flow rate may be higher than, equal to or lower than the flow rate in a normal operating situation.

According to an idea, the flow rate of the regeneration gas RG through the filter 5 is adjusted to be a lot higher than a normal product gas flow rate. An advantage is that the this allows to speed up the cleaning process and, at the same time, the cleaning process can be targeted more uniformly on the filter 5, because a high flow rate forces the regeneration gas RG onto all filter surfaces of the filter 5.

The regeneration gas RG and the gaseous oxidation products, i.e. flue gases, detached from the filter and flowing with the gas exit the arrangement 100 through the discharge channel 8. The discharge channel 8 may lead into a suitable place, such as a torch, power boiler, or the like, in which the flue gases may be processed to the extent necessary in order to be conveyed outdoors. Naturally, the discharge channel 8 may convey flue gases directly outdoors.

In connection with the regeneration also solids S may be created; these may be removed from the filter on an ordinary route known per se.

The basic principle of the method may be as follows: a) filter 5 is separated from the product gas line 2 by closing means 4; b) oxygen-containing control gas CG is fed into the filter 5 separated from the product gas line 2, the gas forming at least part of the regeneration gas RG to be conveyed through the filter 5; c) the regeneration gas RG oxidizes the oxidizing dirt remaining in the filter 5, and d) the regeneration gas RG that has passed through the filter and the oxidization products are removed from the filter 5 through the discharge channel 8.

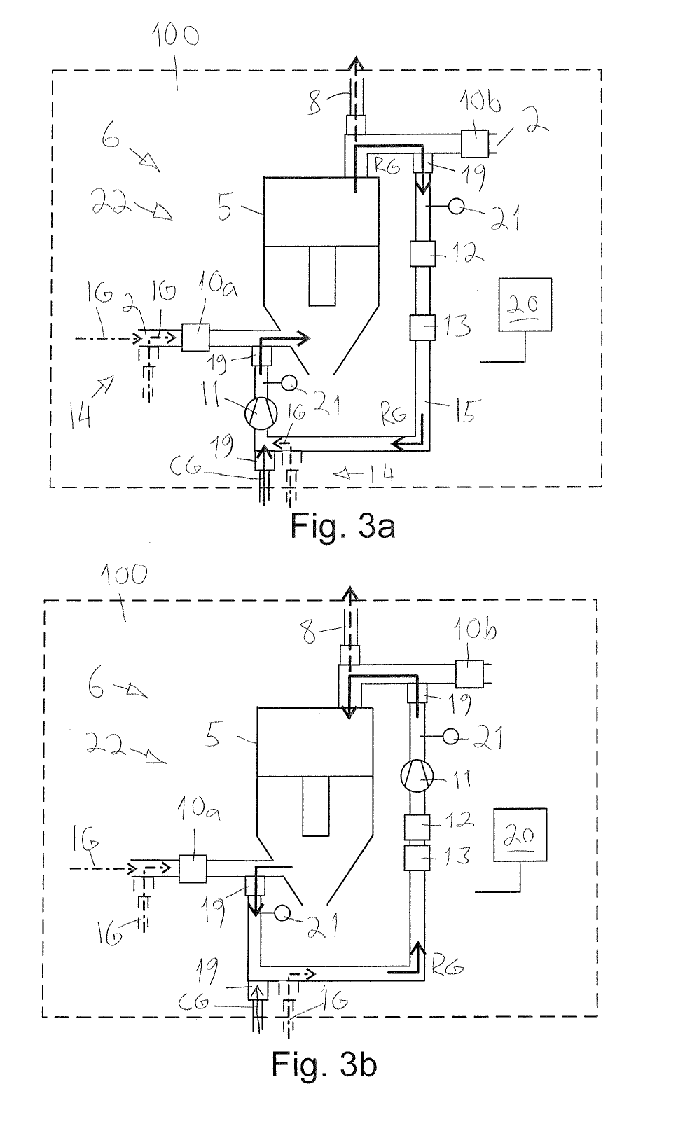

FIG. 3a is a schematic view of a second arrangement and method, and FIG. 3b of a third arrangement and method, which differs from the one in FIG. 3a for the circulation direction of the regeneration gas RG. In FIG. 3a the regeneration gas RG flows through the filter 5 in the same direction as the product gas. In FIG. 3b the flow direction is reverse, i.e. opposite to the flow direction of the product gas.

Also in the arrangement and method of FIG. 2 the regeneration gas RG may be fed into the filter 5 in a direction opposite to the flow direction of the product gas.

The channel system 6 of the arrangement 100 now comprises a recirculation channel 15 arranged between the discharge channel 8 and the feed channel 7. The recirculation channel 15 circulates the regeneration gas RG that has passed through the filter 5 back into the feed channel 7 and from there back to the filter 5. Some of the regeneration gas RG that has passed through the filter 5 is conveyed through the discharge channel 8 out of the arrangement 100. This leaving portion is replaced by feeding replacement control gas CG into the feed channel 7. An advantage of the recirculation channel 15 is that the temperature and composition of the regeneration gas may be controlled better and higher flow rates may be obtained without using a great volume of control gas CG.

The arrangement 100 shown in FIGS. 3a, 3b also comprises scavenging means 14 through which inert scavenging gas IG, which may be e.g. carbon dioxide, nitrogen or water vapour, is fed into the filter 5 separated from the product gas line 2.

The inert scavenging gas IG is preferably fed from the product gas line 2, for example from the production unit 17, or through a feed channel to be opened to the product gas line 2. The inert scavenging gas IG may also be fed into the channel system 6.

Inert scavenging gas IG is preferably fed before feeding regeneration gas RG into the channel system 6 and the filter 5. With the scavenging gas IG the channel system 6 and the filter become cleared of substantially all product gas, the mixture components of which might interfere with the oxidizing reactions during the actual cleaning phase and the controlled temperature adjustment.

When the feeding of the scavenging gas IG is stopped and that of the control gas CG is started, the content of the regeneration gas RG circulating in the filter 5 and the recirculation channel 15 changes gradually, and oxidization products, such as carbon dioxide, become mixed with it as a result of the oxidization of dirt.

It should be noted at this point that some embodiments of the arrangement 100 of FIG. 2 also comprise scavenging means 14 for feeding inert scavenging gas IG.

The cleaning method typically generates heat, which increases the temperature of the regeneration gas RG as it passes through the filter 5. Excess heat energy may be discharged from the circulation in a cooler 12. The cooler 12 may be a heat exchanger known per se and capable of transferring heat energy for use or releasing it in the environment.

The regeneration means 9 may further comprise a heater 13 with which the temperature of the filter 5 may be increased to a level required by the regeneration reactions. This may be necessary at least at the beginning of the regeneration process. According to an idea, the cooler 12 and the heater 13 are one and the same device that is suitably controlled according to process demands. It should be noted at this point that some embodiments of the arrangement 100 of FIG. 2 also comprise a cooler 12 and/or a heater 13.

The operation of the arrangement 100 is controlled by control means 20. The control means 20 are used e.g. for controlling adjusting means 22 which are used for adjusting the oxygen content, temperature and flow rate of the regeneration gas RG. The operation of the arrangement 100 may be fully automated, although alternatively at least some of the measures required by the method are controlled manually. The state of the cleaning process and the functioning of the arrangement 100 are preferably controlled by measuring devices 21 that may measure temperature, flow rate, pressure, oxygen content etc.

When carried out with the arrangement of FIG. 3a or 3b, the regeneration process may proceed as disclosed below, for example:
1. Inert scavenging gas IG is fed until an ambiance suitable for activating the regeneration is achieved in the channel system 6 and the filter 5, and the scavenging gas conduits are shut off.
2. The channel system 6 and the filter 5 are separated from the product gas line 2 with closing arrangements 10a, 10b.
3. The closing means 19 are opened and feeding of the control gas CG into the channel system 6 is started. At first, the oxygen content of the regeneration gas entering the filter 5 may be very low or even at zero.
4. The regeneration gas RG is circulated in the channel system 6 and the filter 5. At first the regeneration gas RG is a mixture of the control gas CG and the scavenging gas IG that was in the channel system 6 and the filter 5 but, as the regeneration reactions start, oxidization products and the like gradually mix with it. In order to get the regeneration reactions activated, the regeneration gas RG may be heated, if necessary, with a heater 13. The use of the heater 13 may be stopped when the reactions increase the temperature of the arrangement 100 to a suitable level.
5. During the entire process temperatures prevailing in the arrangement 100 are measured. If there is a risk of the temperature rising too high, the amount of oxygen to be fed is reduced. This may be carried out by reducing either the flow rate or the oxygen content of the control gas CG. On the other hand, if the temperature drops too much, the amount of the oxygen to be fed is increased.
6. The discharge channel 8 is opened at a suitable point in order to remove the regeneration gas RG and dirt and/or oxidation products carried by the gas. If required, the flow rate of the discharge channel 8 may be adjusted.
7. When the temperature of the arrangement 100 stops rising even though the amount of oxygen fed is increased, the filter 5 is clean of oxidizing dirt. The cleaning process may thus be ended and the filter 5 reconnected to the product gas line 2.

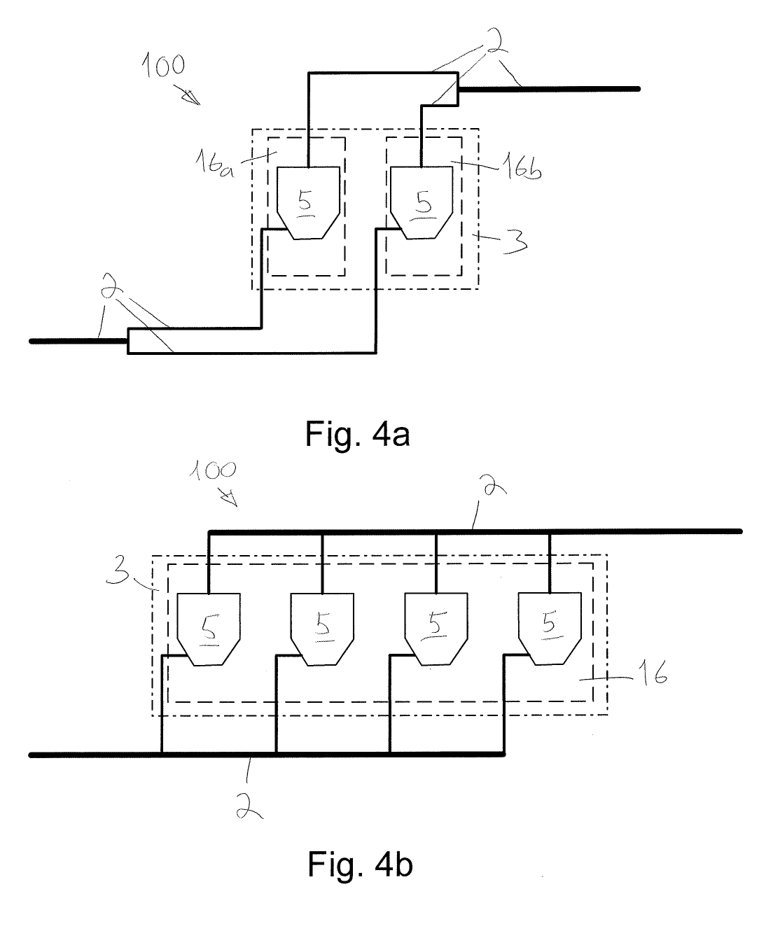

FIGS. 4a, 4b are schematic views of some embodiments of the arrangement and method. It should be noted that only the main lines of the arrangements are shown to simplify the presentation of the matter.

The filter apparatus 3 arranged to the product gas line may comprise a plural number of parallel filters 5 to which the product gas to be filtered is distributed for purification. According to an idea, these filters 5 are divided into a plural number of, at least two, cleaning groups 16a, 16b and the cleaning is arranged to take place one cleaning group at a time. In that case only some of the filters 5 in the filter apparatus 3 are separated for cleaning, whereas the rest of the filters 5 in the filter apparatus 3 are left for use in product gas filtering.

The embodiment of the arrangement 100 shown in FIG. 4a has two cleaning groups 16a, 16b, with one filter 5 in each. Now it is possible to take e.g. the first cleaning group 16a, i.e. the filter 5 contained therein, for cleaning. When the first cleaning group 16a is being cleaned, the second cleaning group 16b may, at the same time, filter product gas. And vice versa. It is thus possible to continue the production of product gas despite the cleaning process. It should be noted that the cleaning group 16a, 16b may even have a plural number of filters 5. The number of the cleaning groups may naturally be greater than two. Likewise, it is evident that all the cleaning groups 16a, 16b may also be cleaned simultaneously.

FIG. 4b illustrates an embodiment with a plurality of filters, in this case four filters 5, arranged into one cleaning group 16. The four filters 5 are all cleaned simultaneously.

It should be noted that the shape and structure of the filter 5 may vary. The filter 5 may comprise a filter hose, filter candle, etc. The filtering material may be metal, ceramic, ceramic non-woven fabric or non-woven mat, etc.

In some cases, features disclosed in this application may be used as such, regardless of other features. On the other hand, when necessary, features disclosed in this application may be combined in order to provide different combinations.

In summary, the arrangement of the invention is characterised in that it comprises: closing means for separating a filter of the filter apparatus from the product gas line, a channel system connected to the filter and comprising a feed channel and a discharge channel, regeneration means for feeding oxygen-containing control gas through the feed channel into the filter separated from the product gas line, the control gas forming at least part of the regeneration gas cleaning the filter, and the discharge channel being arranged to remove from the arrangement regeneration gas that has passed through the filter and material detached from the filter and flowing with the gas.

The method of various embodiments of the invention, in turn, is characterised by: separating a filter of the filter apparatus from the product gas line with closing means, feeding oxygen-containing control gas into the filter separated from the product gas line, the control gas forming at least part of the regeneration gas cleaning the filter, and removing from the filter the regeneration gas that has passed through the filter.

The invention is not limited to the above-described embodiments and many modifications are possible within the scope of the following claims. Indeed, a person of ordinary skill in the art would be able to use the information contained in the preceding text to modify various embodiments of the invention in ways that are not literally described, but are nevertheless encompassed by the attached claims, for they accomplish substantially the same functions to reach substantially the same results. Therefore, it is to be understood that the invention is not limited to the specific embodiments disclosed and that modifications and other embodiments are intended to be included within the scope of the appended claims. Although specific terms are employed herein, they are used in a generic and descriptive sense only and not for purposes of limitation.

### REFERENCE NUMBERS

1 plant producing product gas
2 product gas line
3 filter apparatus
4 closing means
5 filter
6 channel system
7 feed channel
8 discharge channel
9 regeneration means
10a, 10b closing arrangement
11 fan
12 cooler
13 heater
14 scavenging means
15 recirculation channel
16, 16a, 16b cleaning group
17 product gas production unit
18 product gas utilization unit
19 closing means
20 control means
21 measuring device
22 adjusting means
100 arrangement
IG inert scavenging gas
CG control gas
RG regeneration gas
S solids

That which is claimed:

1. An arrangement for cleaning a filter apparatus arranged to a product gas line of a product gas producing plant, the arrangement comprising:
closing means for separating a filter of the filter apparatus from the product gas line;
a channel system connected to the filter and comprising a feed channel and a discharge channel;
regeneration means for feeding oxygen-containing control gas via the feed channel into the filter separated from the product gas line,
wherein:
the control gas forms at least part of the regeneration gas cleaning the filter; and
the discharge channel is arranged for removing from the arrangement regeneration gas that has passed though the filter and the oxidized material flowing with it.

2. An arrangement as claimed in claim 1, further comprising:
measuring means for measuring oxygen content of the regeneration gas to be fed into the filter and/or that has passed through the filter;
measuring means for measuring the temperature of the regeneration gas to be fed into the filter and/or that has passed through the filter; and
adjusting means for adjusting the flow rate and/or composition of the control gas on the basis of said measurements.

3. An arrangement as claimed in claim 1, wherein the closing means comprises a first closing arrangement in the product gas line, before the feed conduit, and a second closing arrangement in the product gas line, after the discharge conduit.

4. An arrangement as claimed in claim 1, wherein the regeneration means comprises a fan for forcing control gas through the filter.

5. An arrangement as claimed in claim 4, wherein the regeneration means further comprises at least one of a cooler or a heater for controlling the temperature of the regeneration gas.

6. An arrangement as claimed in claim 1, wherein the control gas to be used is at least one of oxygen or a gas mixture.

7. An arrangement as claimed in claim 1, wherein the gas mixture is at least one of air or flue gas comprising oxygen.

8. An arrangement as claimed in claim 1, further comprising scavenging means for scavenging a filter separated from the product gas line with inert scavenging gas.

9. An arrangement as claimed in claim 8, wherein the inert rinsing gas comprises carbon dioxide, nitrogen or water vapour.

10. An arrangement as claimed in claim 1, wherein the channel system comprises a recirculation conduit arranged between the discharge channel and the feed channel to recirculate into the feed conduit regeneration gas that has passed through the filter.

11. An arrangement as claimed in claim 1, wherein:
the filter equipment comprises a plural number of parallel filters grouped into at least two cleaning groups; and
the cleaning is arranged to take place according to cleaning groups.

12. A method for cleaning a filter apparatus arranged to a product gas line of a product gas producing plant, the method comprising the steps of:
separating a filter of the filter apparatus from the product gas line with closing means;
feeding oxygen-containing control gas into the filter separated from the product gas line, the control gas forming at least part of the regeneration gas cleaning the filter; and
removing from the filter the regeneration gas that has passed through the filter.

13. A method as claimed in claim 12, further comprising the steps of:
measuring oxygen content of the regeneration gas to be fed into the filter and/or that has passed through the filter;
measuring the temperature of the regeneration gas to be fed into the filter and/or that has passed through the filter; and
adjusting the temperature of the regeneration gas by changing, when necessary, the flow rate and/or composition of the control gas.

14. A method as claimed in claim 12, wherein the flow rate of the regeneration gas is at least equal to a normal product gas flow rate through the filter.

15. A method as claimed in claim 12, wherein the flow rate of the regeneration gas is lower than a normal product gas flow rate through the filter.

16. A method as claimed in claim 12, wherein the regeneration gas that has flowed through the filter is cooled.

17. A method as claimed in claim 12, wherein the regeneration gas to be conveyed to the filter is heated.

18. A method as claimed in claim 12, wherein at least one of oxygen or oxygen-containing gas mixture is fed as control gas.

19. A method as claimed in claim 19, wherein the gas mixture is at least one of air or flue gas.

20. A method as claimed in claim 12, wherein a filter separated from the product gas line is scavenged with inert scavenging gas before feeding the control gas.

21. A method as claimed in claim 20, wherein the inert rinsing gas comprises at least one of carbon dioxide, nitrogen or water vapour.

22. A method as claimed in claim 12, wherein at least some of the regeneration gas that has passed through the filter is recirculated to said filter.

23. A method as claimed in claim 12, wherein only some of the filters of the filter apparatus at a time are separated for cleaning, the rest of the filters in the filter apparatus remaining in use for filtering product gas.

24. A method as claimed in claim 12, wherein regeneration gas is fed through the filter in the flow direction of the product gas.

25. A method as claimed in claim 12, wherein regeneration gas is fed through the filter in an opposite direction with regard to the flow direction of the product gas.
